(19) United States
(12) Patent Application Publication
(10) Pub. No.: US 2009/0250310 A1
(43) Pub. Date: Oct. 8, 2009

(54) TRANSMISSION APPARATUS COMPRISING AT LEAST ONE POSITIVE SHIFTING ELEMENT HYDRAULICALLY ACTUATED BY WAY OF A HYDRAULIC SYSTEM

(75) Inventors: Christian POPP, Kressbronn (DE); Thilo SCHMIDT, Meckenbeuren (DE); Klaus STEINHAUSER, Kressbronn (DE); Jorg ARNOLD, Immenstaad (DE); Valentine HERBETH, Friedrichshafen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/419,731

(22) Filed: Apr. 7, 2009

(30) Foreign Application Priority Data
Apr. 8, 2008 (DE) 10 2008 001 040.5

(51) Int. Cl. F16D 25/063

(52) U.S. Cl. 192/85 R

(57) ABSTRACT

A transmission apparatus (10) having at least one form-lock shifting element (12) that can be actuated by a hydraulic system (11) which, in the region of a piston chamber, can be subjected to hydraulic pressure (p_{—}12) via a hydraulic fluid-conducting feed line (20) and which can be actuated from a disengaged to an engaged operating state. The hydraulic fluid-conducting feed line (20) of the shifting element (12) is effectively connected to a damping device (22) by which pressure fluctuations, of the hydraulic pressure (p_{—}12) in the feed line (20), can be at least partially compensated.

This application claims priority from German patent application serial no. 10 2008 001 040.5 filed Apr. 8, 2008.

### FIELD OF THE INVENTION

The invention relates to a transmission apparatus, comprising at least one positive shifting element that can be hydraulically actuated by way of a hydraulic system.

### BACKGROUND OF THE INVENTION

Transmission apparatuses or automatic transmissions known from practical applications are typically configured with wet friction shifting elements, such as multi-disk clutches or brakes. The transfer capability of such friction shifting elements is applied, for example, by way of an actuating piston to which hydraulic pressure can be applied, with the actuating piston, as a function of the respectively present hydraulic pressure, pressing together a disk pack comprising inner and outer disks of a shifting element with a force that depends on the pressure that is present. The torque to be conducted via a shifting element is ideally proportional to the actuating pressure present on the actuating piston, in order to be able to perform continuous engagement of the clutch.

Using such transmission apparatuses, so-called torque flow-uninterrupted power shifts can be carried out, whereas the torque to be conducted via a transmission apparatus is transmitted prior to a power shift by a shifting element that is engaged in the power flow of the transmission apparatus and transmits the torque and after the power shift via a shifting element that is initially disengaged from the power flow and engaged during the power shift, if the load-conducting shifting element is disengaged to the desired extent during the power shift.

The flow volume required for actuating a friction shifting element behaves continuously relative to the hydraulic pressure present in the hydraulic system, whereas a predictable pressure/volume flow is always obtained from the supplying hydraulic system as a result of the distance/pressure behavior of the shifting element. Due to this predictability, pressure peaks in the hydraulic system can be avoided by suitably controlling the hydraulic system.

Automated manual transmissions and also double-clutch transmissions are often configured with shifting elements or clutches which can only be engaged and disengaged during load-free states or almost load-free states of a transmission apparatus. Such shifting elements are, for example, positive dog clutches or dog locking elements configured with synchronizing units.

In the case of hydraulically actuatable positive shifting elements, the displacement of a hydraulic actuating piston disadvantageously takes place with a strongly varying force-distance curve. As a result, only a small force or a low actuating pressure is required for the displacement of the actuating piston until the actuating piston strikes an obstacle and the movement thereof is stopped. Such an event is triggered, for example, if the halves of a positive shifting element, which are to engage positively with one another during engagement, are in contact with each other without positively locking with each other. During such an operating state of a positive shifting element, basically no torque can be transmitted via a positive shifting element.

Since the movement of the actuating piston of a positive shifting element is suddenly stopped at the time of contact, the flow of hydraulic fluid supplied to the shifting element from the pressure supply of a hydraulic system of the transmission apparatus for actuating the shifting element must be sharply or abruptly reduced.

This results from the fact that during actuation of a positive shifting element, such events depend on the position of the two clutch halves of a positive shifting element relative to one another, and cannot be predicted using known distance measuring systems associated with a positive shifting element, such that corresponding control intervention cannot be initiated in a timely manner.

If the two clutch halves of a positive shifting element which are to be positively engaged in each other mesh after a so-called synchronization phase, the actuating piston of a positive shifting element which continues to be subjected to actuating pressure suddenly continues to move after the meshing time of the shifting element. Due to the sudden movement of the actuating piston, a sharp increase in the hydraulic volume flow from the hydraulic system in the direction of the piston chamber of the shifting element is required, in order to avoid a considerable drop in pressure in the hydraulic system. Raising the hydraulic volume flow, however, can disadvantageously only be carried out with delay by way of a corresponding actuation of different valve devices of the hydraulic system.

Once the actuating piston of the positive shifting element reaches a limit stop that is equivalent to an engaged operating state of the shifting element, the actuating piston in turn is suddenly stopped. In the region of the hydraulic system, this in turn results in a renewed increase of the hydraulic pressure which must be reduced to the necessary level by a corresponding actuation of different components of the hydraulic control system. Reaching the limit stop of the actuating piston prompts a so-called pressure overshoot in the pressure course of the actuating pressure of a positive shifting element.

### SUMMARY OF THE INVENTION

It is therefore the object of the present invention to provide a transmission apparatus comprising at least one positive shifting element that can be hydraulically actuated by way of a hydraulic system, whereas during the actuation of a positive shifting element the pressure fluctuations in the hydraulic system are at least damped in a simple and cost-effective manner as a function of the operating state.

In the transmission apparatus according to the invention, comprising at least one positive shifting element that can be hydraulically actuated by way of a hydraulic system, whereas the shifting element can be subjected to hydraulic pressure in the region of a piston chamber by a hydraulic fluid-conducting feed line and can be brought from a disengaged into an engaged operating state, the hydraulic fluid-conducting feed line of the shifting element is effectively connected to a damping device, by means of pressure fluctuations of the hydraulic pressure present in the feed line can at least be partially compensated for.

As a result, the pressure fluctuations occurring in the hydraulic system in the region of the damping device during actuation of a positive shifting element due to a strongly varying force and distance course are damped, and feedback of massive pressure peaks in the direction of the hydraulic system actuating the shifting element is easily and cost-effectively avoided.

In a simply designed embodiment of the transmission apparatus according to the invention, the damping device comprises a spring device which can be subjected to the hydraulic pressure of the feed line in the region of an effective surface of a damping element and the spring force of which counteracts the pressure force of the hydraulic pressure acting on the damping element.

In an advantageous refinement of the transmission apparatus according to the invention, the spring force of the spring device of the damping device counteracting the hydraulic pressure force is greater than a maximum hydraulic actuating force of an actuating piston of the shifting element, whereby during engagement of a positive shifting element a movement of the actuating piston of the shifting element is not influenced by the damping device, and the damping effect of the damping device does not take place until an undesirable increase of the actuating pressure of the positive shifting element occurs.

In addition or alternatively, in an advantageous embodiment of the transmission apparatus according to the invention, the spring force of the spring device of the damping device counteracting the hydraulic pressure force is smaller than a minimum system pressure of the hydraulic system, whereby the functionality of the damping device is available across the entire operating range of the transmission apparatus.

An embodiment of the transmission according to the invention that is particularly advantageous in terms of installation space and that is easy to install is characterized in that the damping device is integrated in the positive shifting element.

In an advantageous refinement of the transmission apparatus according to the invention, the damping device comprises a simply acting piston-cylinder unit, whereas the damping element of the damping device is configured as a piston that is axially displaceable in a cylinder which preferably is disposed coaxially to the actuating piston of the shifting element. The damping device configured as a piston-cylinder unit constitutes a simple embodiment which is cost-effective to produce and which can be arbitrarily integrated in the transmission apparatus.

The piston of the damping device and the actuating piston of the shifting element are configured as annular pistons radially adjacent to each other in an embodiment of the transmission apparatus according to the invention having low installation space requirement.

In an advantageous refinement of the transmission apparatus according to the invention, the actuating piston of the positive shifting element is associated with a distance measuring system by means of which at least one final position of the actuating piston of the shifting element in which the shifting element is engaged can be verified. In this way, the possibility exists to continuously reduce the hydraulic fluid volume flow fed to the positive shifting element, or the piston chamber thereof, in a simple manner just prior to when the final position of the actuating piston is reached, using a pilot valve or the like, in order to avoid pressure fluctuations in the hydraulic system.

In order to be able to position the damping device in a hydraulic controller of the hydraulic system, a throttle device is disposed between the damping device and a valve device provided for setting the actuating pressure of the positive shifting element.

In an advantageous embodiment of the transmission apparatus according to the invention, a first control guide of the valve device is connected to a system pressure-conducting line and a second control guide of the valve device is connected to a depressurized region of the hydraulic system which can be operatively connected to one another as a function of a position of a valve gate of the valve device, in order to depressurize the positive shifting element or the piston chamber thereof as a function of the operating state.

In order to prevent, during a pressure drop in the hydraulic system below the actuating pressure of the positive shifting element, an undesirable return of the actuating piston into the starting position, the form-locking shifting element is basically in a disengaged operating state, a return stroke valve device is placed upstream of the valve device, by means of which it is ensured that the piston chamber of the positive shifting element is not vented in the direction of the region of the hydraulic pressure that controls the system pressure.

In order to ensure that, during a failure of the valve device provided for setting the actuating pressure of the positive shifting element, the positive shifting element can reliably disengage, it is provided in one embodiment of the transmission apparatus according to the invention that the check valve device is configured such that it can be switched between at least two switch positions, whereas in a first switch position the return stroke valve device can be flowed through in the direction of fill of the piston chamber of the form-lock shifting element and backflow through the check valve device counter to the filling direction of the piston chamber of the positive shifting element is blocked, and whereas in the second switch position of the return stroke valve device hydraulic fluid can be conducted counter to the filling direction of the piston chamber via the return stroke valve device.

Alternatively, the return valve device is configured with a bypass throttle via which hydraulic fluid can be conducted past the return stroke valve device from the form-lock shifting element opposite to the blocking direction of the return stroke valve device, in order to ensure a reliable disengagement of the clutch in the event of failure of the valve device.

### BRIEF DESCRIPTION OF THE DRAWINGS

Further advantages and advantageous refinements of the invention will be apparent from the patent claims and the embodiments described in principle with reference to the drawing, whereas for the benefit of clarity in the description of the embodiments the same reference numerals designate components with an identical design and function.

Shown are:

FIG. 1 is a highly schematic illustration of a vehicle drive train, which is configured with the transmission apparatus according to the invention;

FIG. 2 is a hydraulic circuit diagram of part of a hydraulic system of the transmission apparatus according to FIG. 1, by way of which a positive shifting element is actuated;

FIG. 3 is a second embodiment of the transmission apparatus according to FIG. 1 in an illustration corresponding to FIG. 2;

FIG. 4 is a third embodiment of the transmission apparatus in an illustration corresponding to FIG. 2, in which a damping device is disposed outside a hydraulic controller of the hydraulic system;

FIG. 5 is a fourth embodiment of the transmission apparatus in an illustration corresponding to FIG. 2, wherein a valve device setting an actuating pressure for the positive shifting element is associated with an electro-hydraulic actuator;

FIG. 6 is a highly schematic longitudinal sectional view of a first embodiment of the positive shifting element of the transmission apparatus;

FIG. 7 is a second embodiment of the form-lock shifting element of the transmission apparatus in an illustration corresponding to FIG. 6;

FIG. 8 shows several curves of different operating state parameters of a transmission apparatus during an engagement operation and a subsequent opening operation of a hydraulically actuated, positive shifting element, wherein the transmission apparatus is configured without damping device; and

FIG. 9 shows several curves of different operating state parameters of a transmission apparatus during an engagement operation and a subsequent disengagement operation of a hydraulically actuatable positive shifting element with which a damping device is associated.

### DETAILED DESCRIPTION OF THE PREFERRED EMBODIMENTS

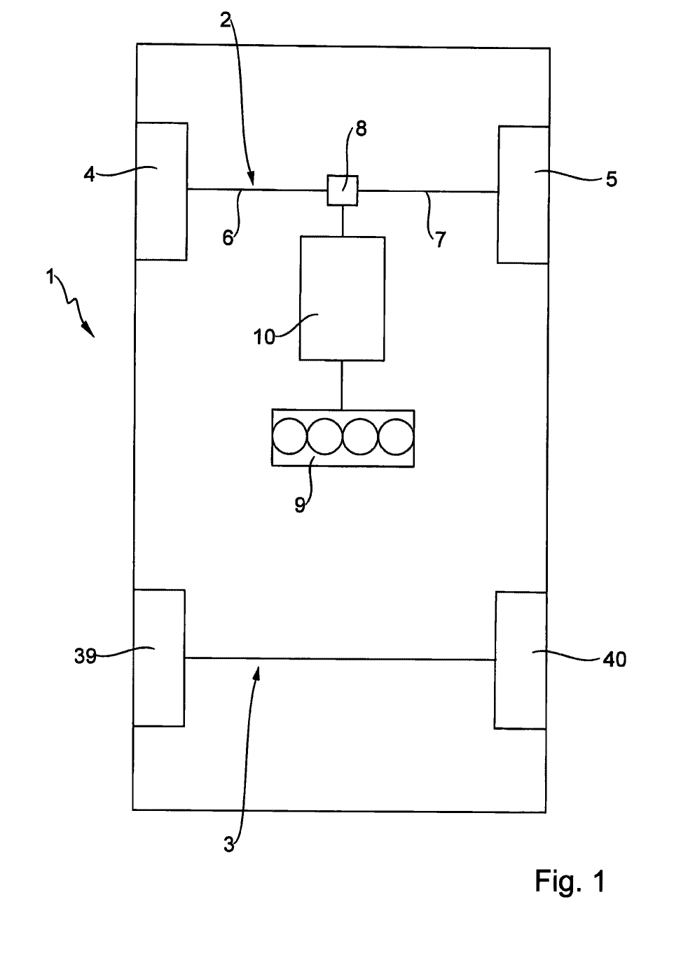

FIG. 1 shows a highly schematic illustration of a drive train of a vehicle 1 having a first vehicle axle 2 and a second vehicle axle 3. The first vehicle axle 2 is a vehicle front axle and the second vehicle axle 3 is the rear axle of the vehicle 1, each being configured with drive wheels 4, 5, or wheels 39, 40. The drive wheels 4, 5 are connected to a differential gear unit 8 by way of two drive shafts 6, 7.

By means of the differential gear unit 8, a drive torque generated by a drive assembly 9 configured in the present example as an internal combustion engine, which can also be an electric motor or a hybrid drive, is equally distributed to the two drive wheels 4 and 5. In addition, a transmission apparatus 10 is provided between the drive assembly 9 and the differential gear unit 8 which can be configured as an automated transmission, as a double-clutch transmission or the like and by means of which different gears can be implemented in the known manner.

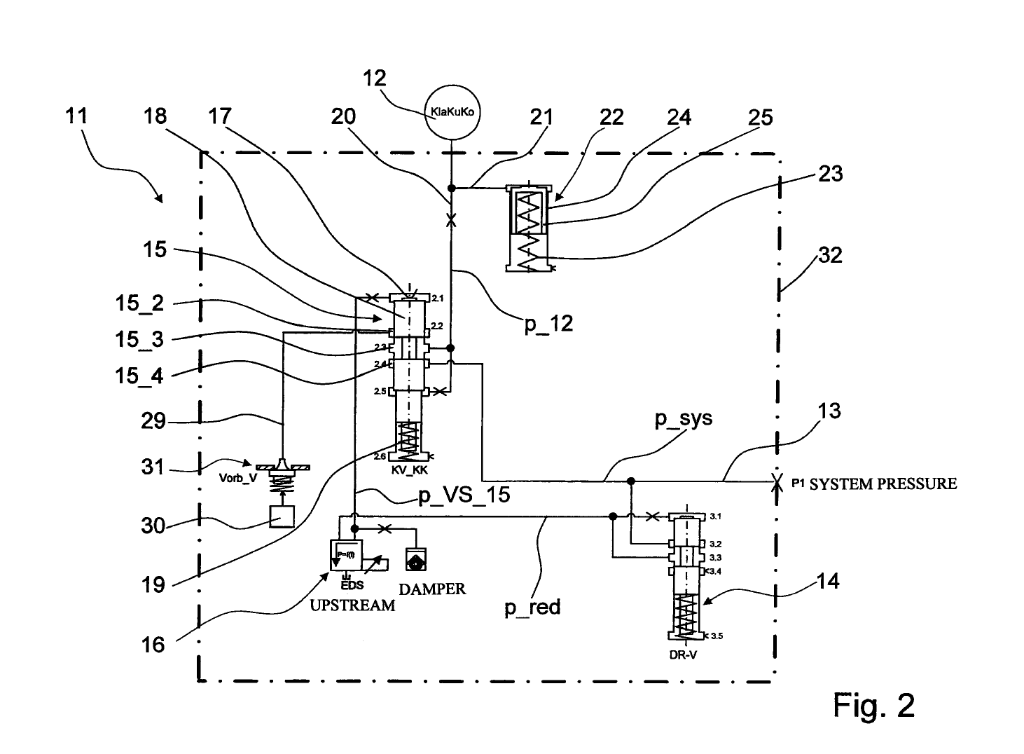

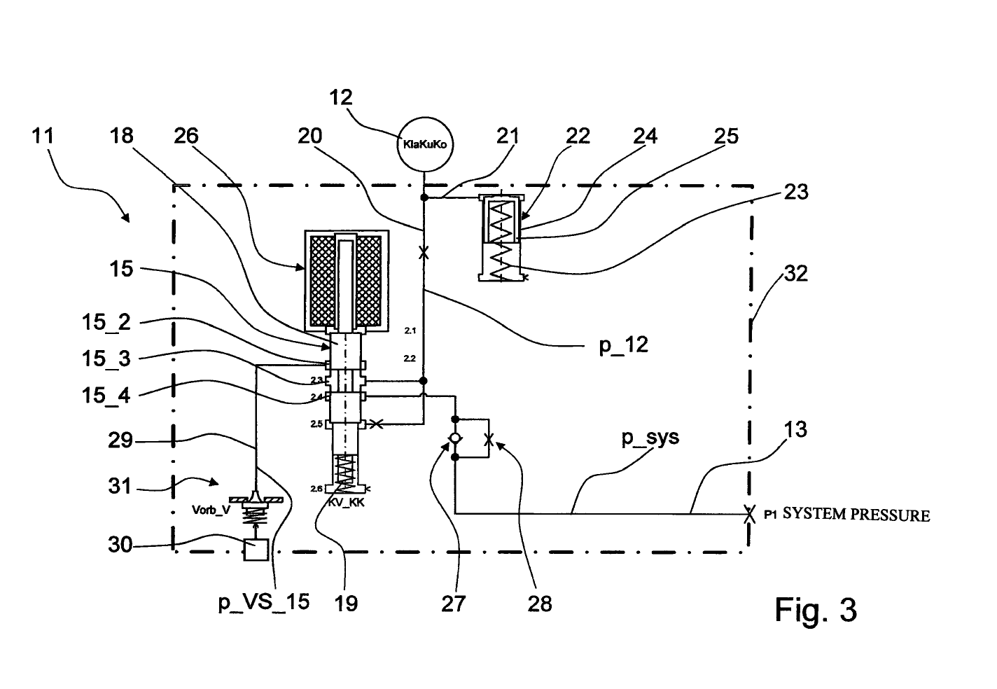

FIGS. 2 to 5 each show a hydraulic diagram of part of a hydraulic system 11 of the transmission apparatus 10, by way of which a form-lock shifting element 12 of the transmission apparatus 10 can be hydraulically actuated. The different embodiments of the hydraulic system 11 of the transmission apparatus 10 only differ from each other in partial regions, which is why in the description of the embodiments according to FIG. 3 to FIG. 5 basically only the differences from the first embodiment of the hydraulic system 11 shown in FIG. 2 are referenced.

In the first embodiment of the hydraulic system 11 shown in FIG. 2, a system pressure p_sys present in the hydraulic system 11 which is regulated in the region of a system pressure valve that is not shown in detail is applied via a first hydraulic line 13. The system pressure p_sys is forwarded both in the direction of a so-called reducing valve 14 and in the direction of a valve device 15. In the region of the reducing valve 14, the system pressure p_sys is set to a reducing pressure p_red which in turn is forwarded in the direction of an electro-hydraulic actuator 16.

In the region of the electro-hydraulic actuator or the electric control valve 16, a so-called pilot pressure p_VS_15 of the valve device 15 is set as a function of a present control current and applied in the region of a control surface 17 of a valve gate 18 of the valve device 15 such that on the valve gate 18 a pressure force is present which results from the pilot pressure p_VS_15 and is directed counter to a spring force of a first spring device 19.

Depending on the pilot pressure p_VS_15, the system pressure p_sys present at a fourth control guide 15_4 of the valve device 15 is forwarded via a third control guide 15_3 in an accordingly modified amount in the direction of the positive shifting element 12 or in the direction of a piston chamber of the shifting element 12, which is not shown in detail.

Between the third control guide 15_3 of the valve device 15 and the form-lock shifting element 12, a second hydraulic line 21 branches off a feed line 20 of the shifting element 12, the hydraulic line connecting the feed line 20 to a damping device 22. Pressure fluctuations can at least be partially compensated for in the feed line 20 by means of the damping device 22.

In order to compensate for the pressure fluctuations, the damping device 22 is configured with a second spring device 23, whose spring force in the present case is applied to a piston 25 which is axially displaceable in a cylinder 24 of a simple acting piston-cylinder unit of the damping device 22 which counteracts the pressure force acting on the piston 25 via the second hydraulic line 21.

In the second embodiment of the hydraulic system 11 shown in FIG. 3, the valve device 15 is configured as a directly controlled actuating valve on which an axial position of the valve gate 18 is set by way of an electromagnetic actuator or a proportional magnet 26.

In addition, a return stroke valve device 27 having a bypass throttle 28 is provided upstream of the valve device 15 or upstream of the fourth control guide 15_4 of the valve device 15. A flow direction of a hydraulic fluid volume flow that is conducted via the first hydraulic line 13 is released in the direction of the valve device 15 and hence of the positive shifting element 12 by means of the return stroke valve device 27, while a backflow starting from the fourth control guide 15_4 of the valve device 15 is blocked by the return stroke valve device 27. In this way, a sudden decline in pressure in the region of the positive shifting element 12 as a result of a pressure drop of the system pressure p_sys is easily and cost-effectively avoided, and any potentially resulting unintentional disengagement of the form-lock shifting element 12 is prevented.

The shifting element 12 can be depressurized in the event of faulty operation of the valve device 15 by way of the bypass throttle 28, whereby a reliable disengagement of the shifting element is ensured, if the valve device 15 should fail. During normal operation of the valve device 15, the feed line 20 can be connected via the valve gate 18 to a second control guide 15-2 which is connected to a depressurized region 30 of the transmission apparatus 10 via a third hydraulic line 29.

In the third hydraulic line 29 a return stroke valve 31 is provided between the second control guide 15_2 of the valve device 15 and the depressurized region 30 or a hydraulic fluid reservoir which in the present case is the oil sump of the transmission apparatus 10. By means of the return stroke valve 31 a complete emptying of the hydraulic system 11 is prevented, since the additional return stroke valve 31 only opens at a pressure value of preferably greater than 0.25 bar.

In the embodiment of the hydraulic system 11 of the transmission apparatus 10 shown in FIG. 2, the hydraulic system 11 is configured without the return stroke valve device 27 and without the bypass throttle 28, so that the shifting element 12 can be depressurized both via the third hydraulic line 19 and, at accordingly low system pressure p_sys, also via the first hydraulic line 13.

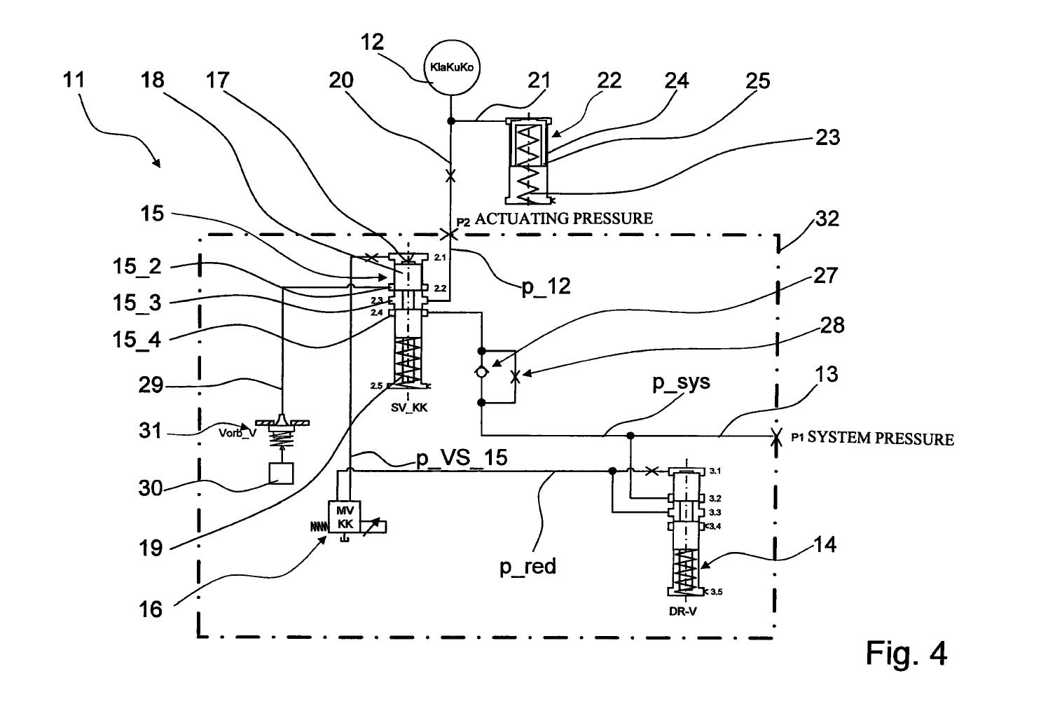

The fourth embodiment of the hydraulic system 11 shown in FIG. 4 is provided with an electro-hydraulic actuator 16 configured as a solenoid valve, in order to be able to set the pilot pressure p_VS_15 of the valve device 15 as a function of the operating state. In the region of the solenoid valve 16, the reducing pressure p_red is accordingly converted as a function of the present actuating current and subsequently forwarded in the direction of the control surface 17 of the valve device 15.

The damping device 22 is disposed outside a hydraulic controller 32 of the hydraulic system 11, whereas between the valve device 15 and the damping device 22 a feed throttle 33A is provided by which the piston 25 of the damping device 22 is disengaged from the valve device 15 controlling the shifting element 12.

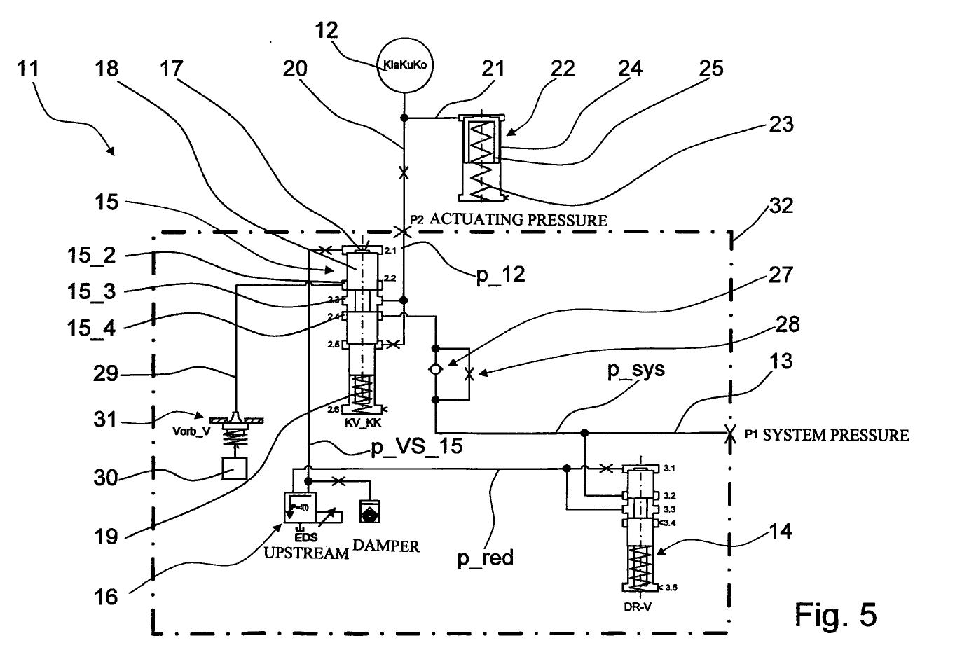

The fourth embodiment of the hydraulic system 11 shown in FIG. 5 substantially corresponds to the first embodiment illustrated in FIG. 2, whereas the damping device 22 contrary to the first embodiment is disposed outside the hydraulic controller 32.

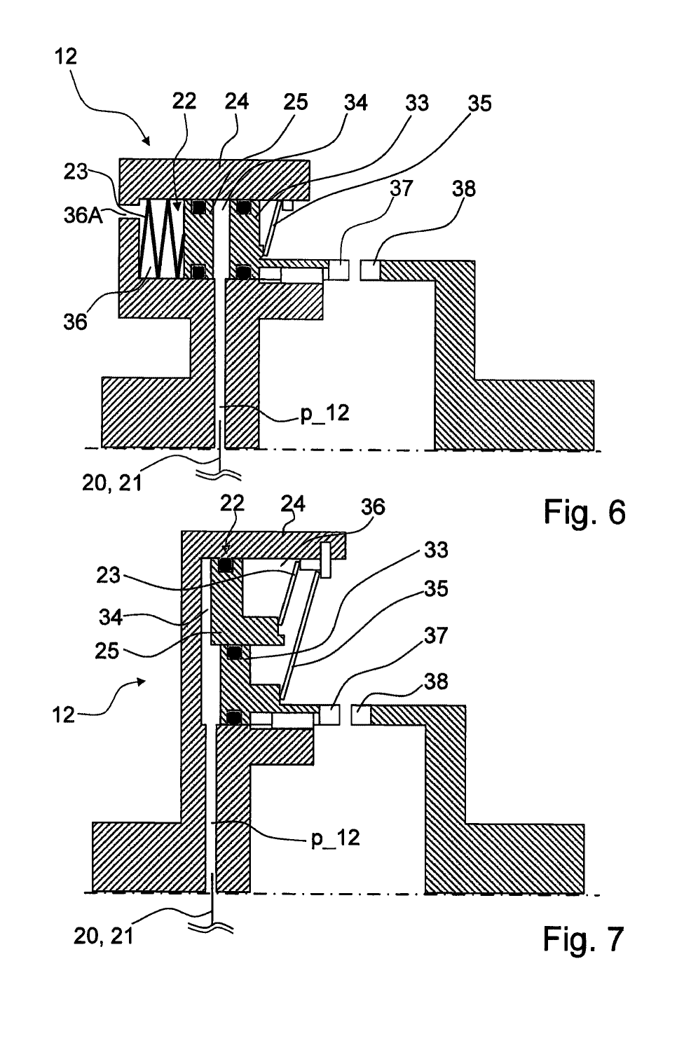

FIG. 6 and FIG. 7 show two embodiments of the form-lock shifting element 12 with more specific design illustrations, in each case in highly simplified, individual, longitudinal cut views, whereas the damping device 22 in both embodiments is integrated into the shifting element 12 in a manner that is advantageous for the installation space.

In the first embodiment of the shifting element 12 of the transmission apparatus 10 shown in FIG. 6, an actuating piston 33 of the shifting element 12 and the piston 25 of the damping device 22 are disposed coaxially to each other and in the axial direction at a distance from each other and delimit a common piston chamber 34 which is subjected to the actuating pressure p_12 set in the region of the valve device 15 via the feed line 20.

The actuating piston 33 is subjected to a spring force of a third spring device 35 acting in the disengagement direction of the shifting element 12 which must be overcome by an actuating pressure p_12 present in the piston chamber 34, in order to engage the form-lock shifting element 12. The second spring device 23 of the damping device 22 is mounted in a spring chamber 36 on the side of the piston 25 facing away from the piston chamber 34. The spring chamber 36 is configured with a venting bore 36A, in order to prevent pressure build-up impairing the function of the damping device 22 in the spring chamber 36 due to leakage currents originating from the piston chamber 34 in the direction of the spring chamber 36.

In the second embodiment of the positive shifting element 12 shown in FIG. 7, the piston 25 of the damping device and the actuating piston 33 of the shifting element 12 are likewise disposed coaxially to each other and configured as annular pistons radially abutting each other, whereas the piston 25 radially surrounds the actuating piston 33.

In both embodiments of the form-lock shifting element 12 according to FIG. 6 and FIG. 7, the pressure-dependent volume flow demand or the change in demand from the part of the hydraulic system 11 that is connected via the first hydraulic line 13 is damped by the piston 25 in the piston chamber 34 of the shifting element 12 such that no massive pressure peaks can be fed back via the first hydraulic line 13 starting from the piston chamber 34.

The actuating piston 33 of the positive shifting element 12 is configured as a simple acting cylinder piston which is brought into a first end position by the third spring device 35 or by a corresponding return spring, in which position the form-lock shifting element 12 is completely disengage if the actuating pressure p_12 drops below a threshold value.

If the hydraulic system 11 is designed for a minimum pressure of 5 bar, the actuating pressure of the return spring or the third spring device 35 of the shifting element 12 is set to approximately 1 to 2 bar. Once a corresponding request for connection to or for engagement of the form-lock shifting element 12 exists, the actuating pressure p_12 is set in the region of the valve device 15 to a pressure value that by far exceeds the spring force of the third spring device 35, whereby for engagement of the positive shifting element the maximum possible volume flow is conducted in the direction of the piston chamber 34.

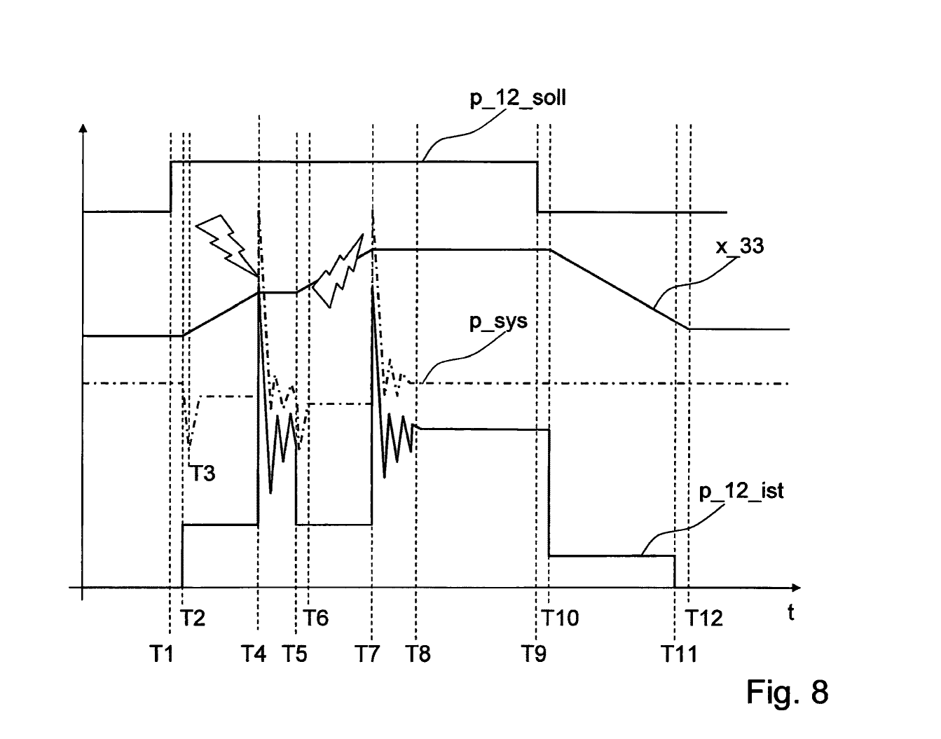

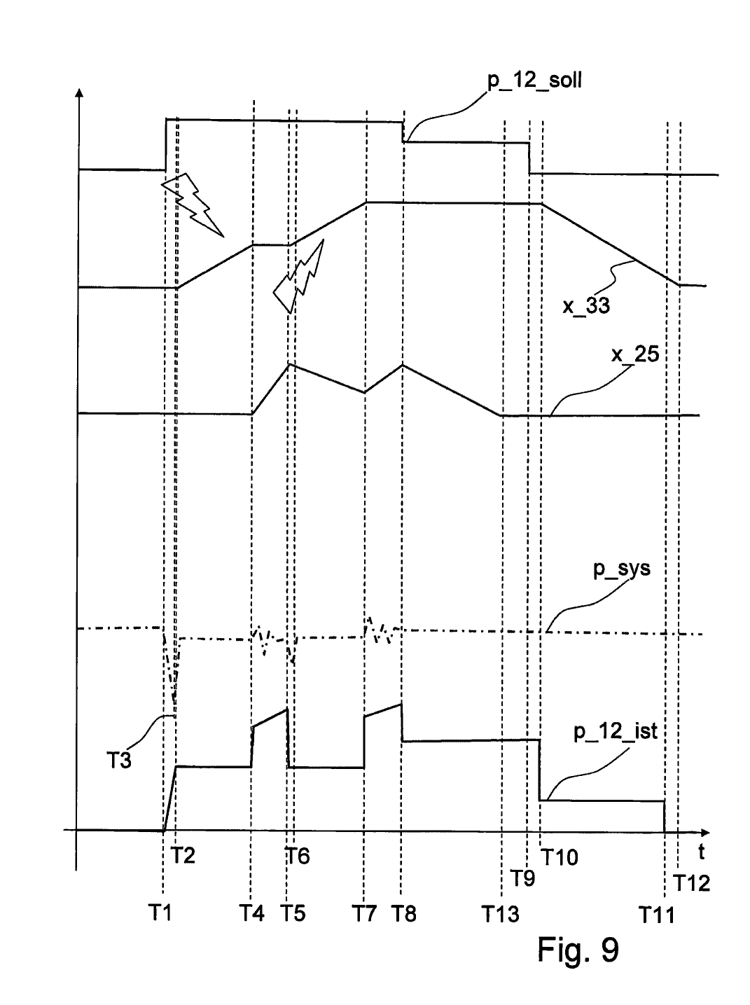

The advantageous action of the damping device 22 will be explained below by a comparison of several curves of different operating state parameters of the transmission apparatus which develop during engagement of the positive shifting element 12, whereas the curves shown in FIG. 8 develop during the engagement of a shifting element that is not associated with a damping device. The curves shown in FIG. 9 develop during engagement of the shifting element 12 which is operatively connected to the damping device 22 in the manner described above.

Shown in FIG. 8 and FIG. 9 in addition to the curve of a target actuating pressure p_12_soll of the form-lock shifting element predetermined by an electric transmission controller and set by the valve device 15 is also an actual actuating pressure p_12_ist of the form-lock shifting element 12 which develops during engagement of the form-lock shifting element extending from a time T1 to a time T7 and a subsequent disengagement phase of the shifting element lasting from time T9 to time T12.

In addition, a curve of the system pressure p_sys present in the hydraulic system 11 upstream of the valve device 15 and a curve of the piston movement x_33 of the actuating piston 33 are shown, whereas in FIG. 9 a curve of the piston movement x_25 of the piston 25 of the damping device 22 is also graphically represented.

At the time T1, when the positive shifting element 12 is in the completely disengaged operating state, the target actuating pressure p_12_soll of the form-lock shifting element 12 is raised to a pressure value that engages the shifting element 12 due to a request generated prior to the time T1 to engage the form-lock shifting element 12.

The target value specification causes the actual operating pressure p_12_ist of the shifting element 12 to likewise increase sharply with a short delay and the actuating piston 33 to be moved from its first end position in which the shifting element 12 is completely disengage, in the direction of its second end position in which the shifting element 12 is completely engaged.

During the movement phase of the actuating piston 33 of the form-lock shifting element 12, starting from its first end position in the direction of its second end position in which a first tooth profile 37 of the shifting element 12 engages a second tooth profile 38 in a form-lock and the form-lock shifting element 12 is in its engaged operating state, a pressure develops in the piston chamber 34 of the shifting element 12 that largely corresponds to a pressure value which is equivalent to the spring force of the third spring device 35.

The system pressure p_sys drops between a time T2 which occurs just a short time after the time T1 and a further time T3 due to the piston movement of the actuating piston 33 of the shifting element 12. After this time, the system pressure p_sys increases again due to a corresponding reaction in the region of the system pressure valve and is then maintained at an at least approximately constant level.

At the time T4 at which a movement of the actuating piston 33 is blocked, both the actual actuating pressure p_12_ist in the piston chamber 34 of the shifting element 12 and the system pressure p_sys rise, whereas in addition the kinetic energy of the hydraulic fluid volume flow previously conducted in the direction of the form-lock shifting element 12 is converted into hydrodynamic pressure and brings about a considerable increase in pressure in the piston chamber 34 and also in the system pressure-conducting region of the hydraulic system 11.

The movement of the actuating piston 33 of the form-lock shifting element 12 is either completed when the second limit stop is reached at the time T7, or is interrupted even before at the time T4, at which a so-called tooth-tooth position exists in which the two tooth profiles 37 and 38 in the region of mutually facing fronts rest against each other and cannot be completely engaged with each other in a form-lock to the desired extent.

The pressure peak in the hydraulic system 11 triggered at the time T4 by the sudden stop of the piston movement and shown in FIG. 8 is damped by the independent and simple acting piston 25 which is associated with a separate return spring or the second spring device 23 or by the movement thereof in the manner shown in FIG. 9, such that upstream of the valve device 15 a negative feedback on the remaining hydraulic system of the transmission apparatus 10 is avoided. The reduced feedback is graphically represented in FIG. 9 by the pressure fluctuations of the system pressure p_sys between the times T4 and T6, which are reduced when compared to the curve of the system pressure p_sys according to FIG. 8.

The second spring device 23 of the damping device 22 is therefore dimensioned such that, starting from a threshold value of the actuating pressure which ideally is below the minimum system pressure p_sys of preferably 5 bar and above the maximum actuating pressure of the actuating piston 32, the piston 25 is moved in the manner shown in FIG. 9 from its first non-actuated end position in the direction of its second end position.

This design of the second spring device 23 of the damping device 22 causes the piston 25 of the damping device 22 to remain in a first non-actuated end position during the movement of the actuating piston 33 of the positive shifting element 12, since the actual actuating pressure p_12_ist in the piston chamber 34 of the shifting element 12 during the movement of the actuating piston 33 corresponds to a pressure value that is equivalent to the spring force of the third spring device 35, the pressure value being smaller than the actuating pressure of the piston 25 or the damping device 22.

As soon as the piston movement of the actuating piston 33 is stopped, the pressure in the piston chamber 34 rises to the pressure level of the third spring device 23 of the damping device 22, whereby the piston is displaced from its first end position in the direction of a second end position in which the volume of the hydraulic system 11 in the region downstream of the valve device 15 is increased. If the second spring device 23 of the damping device 22, for example, is configured for an actuating pressure of 4 bar, the pressure in the piston chamber 34, or downstream of the valve device 15, increases to a maximum of 4 bar as long as the piston 25 of the damping device 22 is being moved, whereas the hydraulic fluid volume flow conducted in the direction of the form-lock shifting element 12 can initially be maintained at a largely constant level.

At a time T5 at which the actuating piston 33 of the now engaged shifting element 12 continues to be moved in the direction of its second end position, the actual actuating pressure p_12_ist downstream of the valve device 15 and in the piston chamber 34 drops to the level of the third spring device 35. The piston 25 is not displaced any further in the direction of the second end position.

Because the actual actuating pressure p_12_ist downstream of the valve device 15 or in the region of the feed line 20 and the piston chamber 34 is lower after the time T5, the piston 25 is pushed back by the associated spring device 23 in the direction of its first end position. During this actuation phase of the shifting element 12, the hydraulic fluid volume flow conducted upstream of the valve device 15 in the direction of the shifting element 12 is reduced due to the previously occurring pressure peak in the hydraulic system 11 by appropriate transmission controller specifications. By returning the piston 25 in the direction of its first end position, part of the hydraulic fluid volume required for actuating the shifting element 12 is returned into the hydraulic system 11, thereby at least partially compensating for the reduction of the hydraulic fluid volume flow.

At the time T7, the actuating piston 33 reaches its second limit stop, as a result of which the actual actuating pressure p_12_ist in the piston chamber 34 rises again. This in turn results in a further, not insignificant increase in the actual actuating pressure p_12_ist and system pressure p_sys between the times T7 and T9 for a transmission apparatus that has no damping device. These pressure peaks are avoided by the damping device 22 or by an actuation of the piston 25 in the direction of its second end position occurring between the times T7 and T8 in the magnitude shown in FIG. 9, or such pressure peaks are considerably reduced compared to a transmission apparatus without a damping device.

At the same time, the hydraulic fluid volume flow conducted in the direction of the form-lock shifting element 12 is continuously reduced by the pilot valve or the electro-hydraulic actuator 16 or by appropriate energization of the electromagnetic actuator 26, in order to keep the pressure peaks in the hydraulic system as low as possible, whereas a distance measuring system, which is known per se and not shown in detail in the figure, verifies that the second limit stop or the second end position of the actuating piston 33 has been reached and that the control of the valve device 15 required to do so can be implemented in a timely manner.

In the completely engaged operating state of the form-lock shifting element 12, which is to say in a static state between the times T8 and T9, the pilot pressure p_VS_15 in the embodiments of the hydraulic system 11 according to FIG. 2, FIG. 3, and FIG. 5 is set to a level in the manner shown in FIG. 9 at which the actuating piston 33 of the shifting element 12 remains in its second end position by way of the constant actual actuating pressure p_12_ist. The piston 25 of the damping device 22 is pushed back into its first end position or its starting position until the time T13.

In the embodiment of the hydraulic system 11 according to FIG. 3, the actuating pressure p_12 in the feed line 20 or in the piston chamber 34 is set accordingly by appropriate energization of the electromagnetic actuator 26 of the valve device 15.

Starting from the engaged operating state of the shifting element 12 last described in which the piston 25 is in its first end position, the fastest possible disengagement of the form-lock shifting element 12 is ensured, since the disengagement operation of the shifting element 12 is not delayed by movement of the piston 25 in the direction of its first end position and an attendant displacement of hydraulic fluid volume into the feed line 20 or in the piston chamber 34.

At the time T10, at which a request for disengaging the shifting element 12 is present, the target actuating pressure p_12_soll of the shifting element 12 is lowered, the actuating piston is displaced by the third spring device 35 into its first end position, and the shifting element 12 is disengaged, whereas the actual actuating pressure p_12_ist during the piston movement of the actuating piston 33 corresponds to the level of the third spring device 35 and, when the shifting element 12 is completely disengaged, it corresponds to the prefill pressure of the hydraulic system 11 set by the further check valve 31.

In general, the actuation of the actuating piston 33 of the form-lock shifting element 12 is ideally designed for a pressure level such that the actuating piston 33 is actuated below the minimum pressure value of the system pressure p_sys. If the pressure value of the system pressure p_sys in the hydraulic system 11 drops below the actuating pressure of the actuating piston 33 of the shifting element 12, however, the undesirable possibility exists that the actuating piston 33 is moved back by the third spring device 35 in the direction of its first end position and the positive shifting element is unintentionally disengaged.

By means of the return stroke valve device 27, it is ensured that the actuating piston 33 does not disadvantageously return into its starting position during unintentional pressure drops in the hydraulic system 11. In general, during unfavorable operating states of the hydraulic system in the event of pressure drops in the hydraulic system 11 occurring due to the fact that the operating pressure cannot be held constant, the valve device 15 without the return stroke valve device 27 is transferred into an operating state in which the connection between the positive shifting element 12 and the system pressure supply or the first hydraulic line 13 is completely opened. By disposing the return stroke valve device 27 upstream of the fourth control guide 15_4 of the valve device 15, it is ensured that the piston chamber 34 of the form-lock shifting element 12 is not purged in the direction of the system pressure p_sys conducting region of the hydraulic system 11.

In the embodiments shown in the drawing, the return stroke valve device 27 is configured with the bypass throttle 28, by way of which it is again ensured that the form-lock shifting element 12 can be reliably transferred into an disengaged operating state despite failure of the valve device 15. If the valve device 15 is fully functional, the shifting element 12 is disengaged by connecting the operating pressure and the tank connection 15_2 of the valve device 15.

Alternatively to the embodiments of the damping device shown in the drawing which are all configured with a piston provided with resilience by a spring device, the damping device, as a function of the respectively present application, can also be configured with a diaphragm spring, a gas spring, or also with a diaphragm-gas spring combination with or without additional mechanical spring element, such as a helical spring, a disk spring, a spring element package or the like, and/or with a reversibly deformable elastic damping element, by means of which the pressure fluctuations in the feed line of the form-lock shifting element can be at least partially compensated for in the manner described above during an actuation of the form-lock shifting element.

### REFERENCE NUMERALS

1 Vehicle
2 First vehicle axle
3 Second vehicle axle
4,5 Drive wheel
6,7 Drive shaft
8 Differential gear unit
9 Drive assembly
10 Transmission apparatus
11 Hydraulic system
12 Shifting element
13 First hydraulic line
14 Reducing valve
15 Valve device
15_2 to 15_4 Control guide
16 Electro-hydraulic actuator
17 Control surface
18 Valve gate
19 First spring device
20 Feed line
21 Second hydraulic line
22 Damping device
23 Spring device
24 Cylinder
25 Piston
26 Electro-magnetic actuator
27 Check valve device
28 Bypass throttle
29 Third hydraulic line
30 Depressurized region
31 Further check valve
32 Hydraulic controller
33 Actuating piston
33A Throttle device, feed throttle
34 Piston chamber
35 Third spring device
36 Spring chamber
36A Venting bore
37 First tooth profile
38 Second tooth profile
39,40 Wheel
p_red Reducing pressure
p_sys System pressure
p_VS_15 Pilot pressure
p_12 Actuating pressure of the shifting element
t Time
T0 to T13 Discrete time

1-13. (canceled)

14. A transmission apparatus (10) comprising at least one form-lock shifting element (12) that is hydraulically actuated by a hydraulic system (11), the shifting element (12) being subjectable to hydraulic pressure (p_12_ist) by a hydraulic fluid-conducting feed line (20), in a region of a piston chamber (34), and being actuatable between a disengaged and an engaged operating state, the hydraulic fluid-conducting feed line (20) of the shifting element (12) being effectively connected to a damping device (22) so that pressure fluctuations of the hydraulic pressure (p_12_ist), present in the hydraulic fluid-conducting feed line (20), are at least partially compensated.

15. The transmission apparatus according to claim 14, wherein the damping device (22) comprises a spring device (23) which, in a region of a damping element (25), is subjected to the hydraulic pressure (p_12_ist) present in the hydraulic fluid-conducting feed line (20), and a spring force of which counteracts a pressure force of hydraulic pressure acting on the damping element (25).

16. The transmission apparatus according to claim 15, wherein the spring force of the spring device (23) of the damping device (22), counteracting the hydraulic pressure force, is greater than a maximum hydraulic actuating force of an actuating piston (33) of the shifting element (12).

17. The transmission apparatus according to claim 15, wherein the spring force of the spring device (23) of the damping device (22), counteracting the hydraulic pressure force, is smaller than a minimum system pressure (p_sys) of the hydraulic system (11).

18. The transmission apparatus according to claim 14, wherein the damping device (22) is integrated in the form-lock shifting element (12).

19. The transmission apparatus according to claim 16, wherein the damping device (22) comprises a simple acting piston-cylinder unit and the damping element (25) is a piston that is axially displaceable in a cylinder (24), the piston being disposed coaxially with the actuating piston (33) of the shifting element (12).

20. The transmission apparatus according to claim 19, wherein the piston (25) of the damping device (22) and the actuating piston (33) of the shifting element (12) are annular plungers which radially abut one aneach other.

21. The transmission apparatus according to claim 16, wherein the actuating piston (33) of the shifting element (12) communicates with a distance measuring system which verifies at least one end position of the actuating piston (33) in which the shifting element (12) is in the engaged operating state.

22. The transmission apparatus according to claim 14, wherein a throttle device (33A) is disposed between the damping device (22) and a valve device (15), which is provided for setting the actuating pressure of the positive shifting element (12).

23. The transmission apparatus according to claim 22, wherein a control guide (15_4) of the valve device (15) is connected to a system pressure (p_sys) conducting line (13) and a further control guide (15_2) of the valve device (15) is connected to a depressurized region (30) of the hydraulic system (11) which are effectively connected to one another as a function of a position of a valve gate (18) of the valve device (15).

24. The transmission apparatus according to claim 22, wherein a return stroke valve device (27) is arranged upstream of the valve device (15).

25. The transmission apparatus according to claim 24, wherein the return stroke valve device (27) is switchable between at least first and second switch positions, in the first switch position, hydraulic fluid flows through the return stroke valve (27) device in a filling direction of the piston chamber of the form-lock shifting element (12) and backflow of the hydraulic fluid, through the return stroke valve device (27) counter to the filling direction of the piston chamber of the form-lock shifting element (27), is blocked and, in the second switch position of the return stroke valve device (27), the hydraulic fluid flows counter to the filling direction of the plunger chamber via the return stroke valve device (27).

26. The transmission apparatus according to claim 25, wherein the return stroke valve device (27) has a bypass throttle (28) via which the hydraulic fluid flows from the shifting element (12), past the return stroke valve device (27), counter to the blocking direction of the return stroke valve device (27).
